(19) United States
(12) Patent Application Publication
(10) Pub. No.: US 2006/0280052 A1
(43) Pub. Date: Dec. 14, 2006

(54) METHOD AND APPARATUS FOR EJECTING AN OPTICAL DISC

(75) Inventor: Akira Nishida, Torrance, CA (US)

Correspondence Address: DVA / PIONEER ELECTRONICS SERVICE, INC., 2355 MAIN STREET, SUITE 200, IRVINE, CA, 92614, US

(73) Assignee: PIONEER ELECTRONICS SERVICE, INC., Long Beach, CA (US)

(21) Appl. No.: 10/908,754

(22) Filed: May 25, 2005

(51) Int. Cl. G11B 7/085

(52) U.S. Cl. 369/30.27

(57) ABSTRACT

The invention works in an environment where an optical disc, such as a CD, is inserted into an optical disc player. The disc typically has a label that is affixed to an upper surface of the disc. If the label is loose, for instance if a portion of the disc becomes raised toward the grill, the CD will become stuck since the raised label will not exit the opening in the grill. This obstructs the disc rollers and causes the motor to not be able to push the disc out of the player. The present invention senses this event and invokes an ejection routine to allow the raised label portion to be rotated to a position where it will not obstruct the slit in the grill or the roller.

### NOTICE OF MATERIAL SUBJECT TO COPYRIGHT PROTECTION

All of the material in this patent document is subject to copyright protection under the copyright laws of the United States and of other countries. Portions of the material in this patent document are also subject to protection under the maskwork registration laws of the United States and of other countries. The owner of the copyright and maskwork rights has no objection to the facsimile reproduction by anyone of the patent document or the patent disclosure, as it appears in the United States Patent and Trademark Office file or records, but otherwise reserves all copyright and maskwork rights whatsoever.

### BACKGROUND OF THE INVENTION

1. Field of the Invention

The present invention relates generally to optical disc players.

2. Background of the Invention

Optical disc players have become one of the most popular mechanisms by which a user is able to listen to music, watch movies, or otherwise use data that can be encoded onto a spiral track on the disc and operated by the optical disc player. Optical disc players in automobiles, for instance, or other situations where CD players are installed and are able to receive discs become problematic when the player malfunctions and cannot eject the disc.

In particular, players like those common in automobiles have a grill with an opening on the face of the grill and rollers inside the player used in conjunction with motors and braking mechanisms to smoothly guide the disc into the player so it can be used. When the user wants to eject the disc, the same type of mechanism reverses the process where rollers, motors, and brakes smoothly push the disc partially out of an opening in the grill, to where the user can grasp the disc with their hand and remove it.

With the advent of CD burners and music encoded in a computer readable form, such as mp3s, it has become common for users to arrange their own customized music or video selections on an optical disc and to label the optical disc so that it is easy to determine the content of any particular disc. The most common form of labeling is using a paper having an adhesive on one side “a sticker”, so that it can be affixed to the disc and then the user can write on the label to easily identify its content. Such labels suffer the disadvantage that over time the adhesive wears out and the label can start coming loose at the edges. Moreover the label adds an additional, albeit small, height to the disc that is relevant in a sensitive optical disc holder or carriage. In many carriages, many optical discs are stacked on top of one another in the carriage and if each CD includes an additional label, there is a noticeable upward adjustment in the position of the carriage relative to the opening where the disc is ejected.

In either case, current CD labeling causes a problem. For instance, if the label becomes unstuck at an edge and that edge happens to be aligned with the rollers inside the player (or the opening in the grill), the label can move above the opening in the grill, which stops the roller from ejecting the disc. In such a case, the player must be returned for service where a technician must take the player apart and remove the disc. This situation however is problematic because the user must take their car in for service each time and this problem is becoming increasingly common.

### SUMMARY OF THE INVENTION

The invention works in an environment where an optical disc, such as a CD, is inserted into an optical disc player. The disc typically has a label that is affixed to an upper surface of the disc, although the present invention will operate on any disc, labeled or unlabeled. If the label is loose, for instance if a portion of the disc becomes raised toward the grill, the CD will become stuck since the raised label will not exit the opening in the grill. This obstructs the disc rollers and causes the motor to not be able to push the disc out of the player. The present invention senses this event and determines that the CD has not been ejected properly. When this happens, the player performs an ejection routine to allow the unstuck label to move to a position where it will not obstruct the slit in the grill or the roller.

In one embodiment, the user inserts a disc into an optical disc player. A loader function is activated, which uses a sensor near the opening of the player to sense that the disc has been inserted, and causes a motor to turn a roller. The roller pulls the disc into the player. When the user attempts to eject the disc, the loader function is activated again. In a multiple disc CD changer, a tray holding the CDs is put into a position of alignment with the opening through a vertical movement. The loader function then activates the motor again which turns the roller in the opposite direction and attempts to push the disc out of the opening in the player.

The sensor, which detects the physical presence of the disc, is used to determine that the loader has not been successful (i.e., the disc is still present in the player). When this occurs an ejection routine is invoked. The ejection routine comprises reactivating the motor with a motor controller to cause the roller to pull the disc back into the player. The disc reaches its final position when it is positioned in alignment with a spindle motor or a stepper motor so the disc can be rotated. The player status is then returned to Play, rotating the disc approximately 90 degrees. The system then tries to eject the disc again and repeats the process. Typically the disc will safely be ejected after the disc has been turned between 90 and 270 degrees. One skilled in the art will understand that other degrees of rotation will suffice so long as the raised portion of the sticker is directed substantially away from the roller.

### BRIEF DESCRIPTION OF THE DRAWINGS

The invention will be more fully understood by reference to the following drawings, which are for illustrative purposes only:

FIG. 1 is a block diagram of an optical medium with a loose label.

FIG. 2 is a block diagram of a typical throttle player with a disc inserted with a loose label.

FIG. 3 is a block diagram of an ejection mechanism according to an embodiment of the present invention

FIG. 4 is a flowchart of an ejection routine according to an embodiment of the present invention.

FIG. 5 is a block diagram of an ejection mechanism that uses an ejection routine according to an embodiment of the present invention.

FIG. 6 is a flowchart of an ejection routine according to an embodiment of the present invention.

FIG. 7 is a block diagram of an optical disc player with an ejection mechanism according to an embodiment of the present invention.

FIG. 8 is a flowchart showing the operation of an optical disc player with an ejection mechanism according to an embodiment of the present invention.

### DETAILED DESCRIPTION OF THE INVENTION

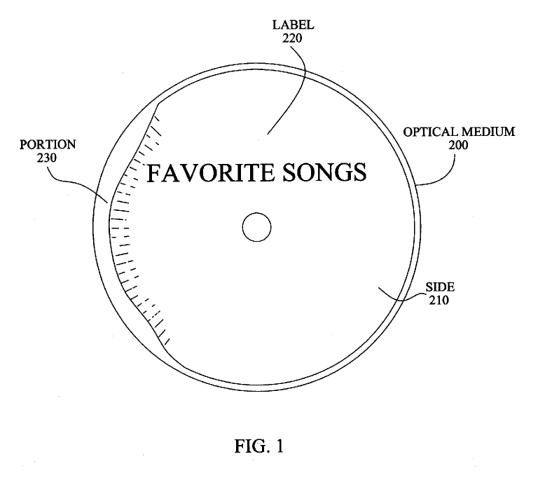

The present invention operates in an environment where an optical disc, such as a CD, is inserted into an optical disc player, such as a single-disc player or a multi-disc changer. If the label on the disc becomes loose, for instance if a portion of the label becomes raised where the adhesive becomes weak, the scenario shown in FIG. 1 occurs. FIG. 1 is an example of an optical medium that includes a label that has loosened. In medium 200 the spiral track is behind side 210 so it is not visible. Medium 200 has a label 220, for instance a sticker, which is common in labeling discs. Portion 230 of optical medium 200 represents the area where label 220 has become loose and raised, either through carelessness of the user who applied the label 220, through deterioration of the adhesive over time, or for any other reason.

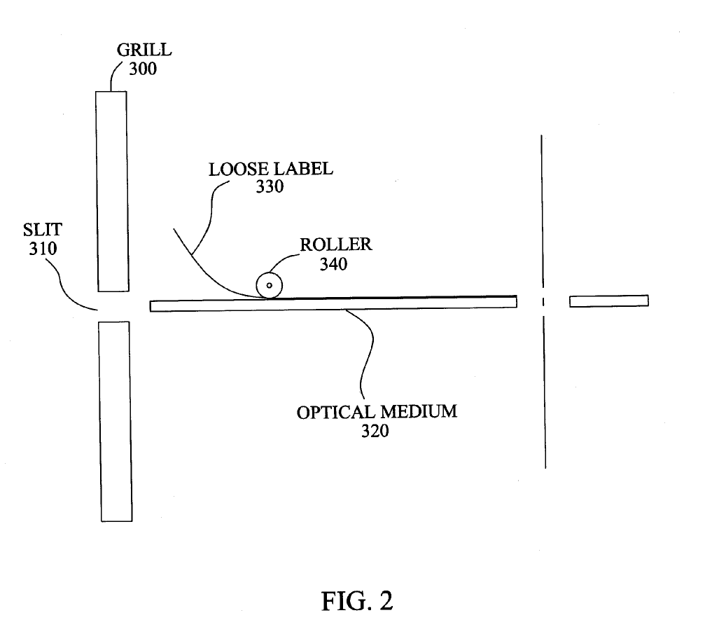

Optical medium 200 may become stuck in certain scenarios, since the raised label may not exit the opening in the grill of the player if the disc aligns in certain configurations. FIG. 2 shows an example where such a scenario may occur. In FIG. 2, optical medium 320 is inserted into the player through slit 310 in grill 300. Roller 340 is designed, in part, to assist in ejecting medium 320. Label 330 on medium 320 has become loose. As is shown in FIG. 2, label 330 is no longer in alignment with slit 310 even though medium 320 is still aligned with slit 310. Upon a command to perform ejection, roller 340 spins in a clockwise direction. If this happens, label 330 will be pushed against grill 300 and not through slit 310. The force of roller 340 is not sufficient to overcome the force of the label 330 pushing against the grill 300. As such, the medium 320 will become stuck using a prior art ejection mechanism. Only the removal of grill 300 will allow a technician to remove medium 320, which is time consuming and expensive.

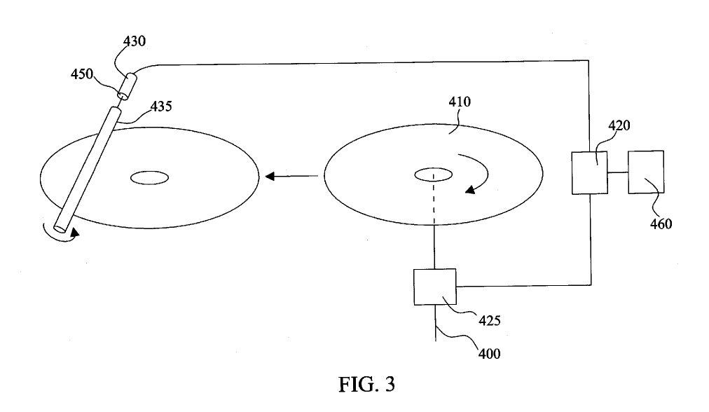

FIG. 3 is a diagram showing an ejection mechanism according to an embodiment of the present invention. Spindle 400 is used to spin medium 410 using motor controller 420 to operate spindle motor 425, also interchangeably called a stepper motor. Motor controller 420 also controls roller 435 using motor 430. A sensor 450 is used in conjunction with motor controller 420 and motor 430. When the medium 410 is in use, spindle 400 rotates medium 410 at the appropriate speed. When the medium 410 is intended to be ejected, motor controller 420 rotates roller 430 so that medium 410 slides out of the player via a loader mechanism.

In some scenarios, the ejection of the medium 410 is not successful. For instance, sensor 450 may be used to recognize that the ejection attempt has been unsuccessful and the disc is physically still present inside the player. Sensor 430 is typically located near the slit in the grill, in close proximity to medium 410 and senses the physical presence of the medium 410 near the sensor 450. If the medium 410 is successfully ejected the sensor 450 is able to determine that it is no longer physically present in the drive. When the ejection attempt is not successful, the sensor 450 shows that the medium 410 is still present and hence, the medium 410 was not properly pushed out of the player.

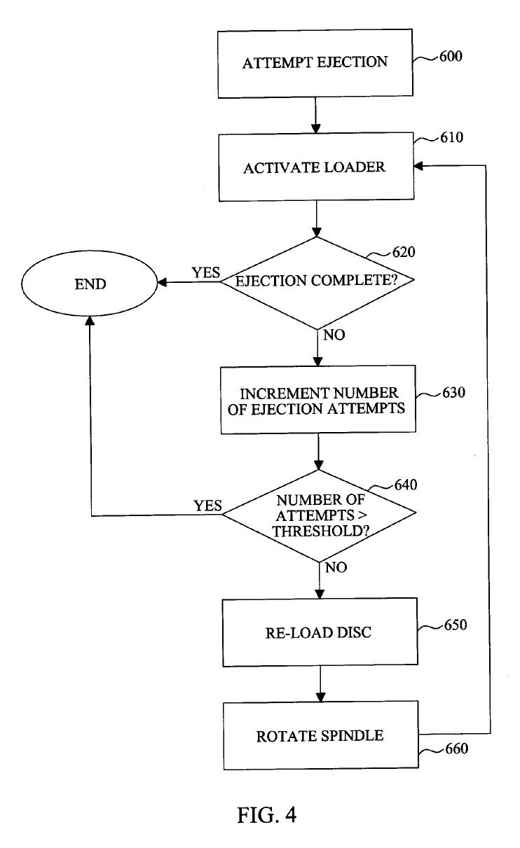

When sensor 450 determines that an ejection did not succeed, routine 460 is invoked to attempt a successful ejection of the medium 410. Routine 460 can be hardware, software, firmware, or a combination of all three. Routine 460 typically operates in conjunction with a computing device known to those skilled in the art to carry out instructions to the player. In one embodiment of the present invention, routine 460 operates as shown in FIG. 4.

FIG. 4 is a flowchart showing the operation of an ejection routine according to an embodiment of the present invention. At block 600 an attempt is made to eject the disc. At block 610 a loader is activated to carry out the attempted ejection of the disc. At block 620 it is determined if the ejection is complete. If so, the process ends. Otherwise at block 630 the number of ejection attempts is incremented. At block 640 it is determined if the number of ejection attempts exceeds a threshold number of times to try to eject the disc. This number, for instance, may be set to 5 ejection attempts. If so, the process is complete. Otherwise, the disc is loaded again at block 650. At block 660 the spindle is rotated and the process repeats at block 610.

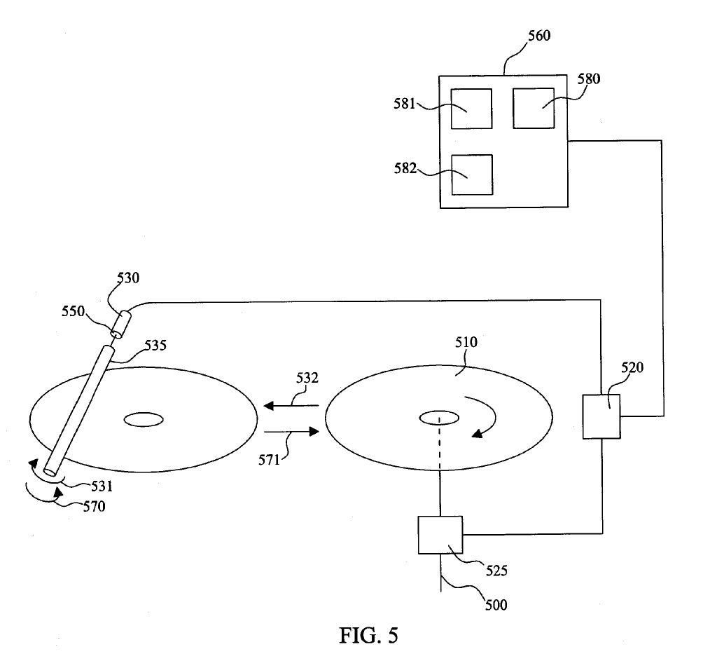

FIG. 5 is a block diagram showing an ejection mechanism that uses an ejection routine according to an embodiment of the present invention. Spindle 500 spins medium 510 using motor controller 520 to operate spindle motor 525. Motor controller 520 also controls roller 535 using motor 530. A sensor 550 is used in conjunction with motor controller 520 and motor 530. When the medium 510 is in use, spindle 500 rotates medium 510 at the appropriate speed and in the appropriate direction. When the medium 510 is intended to be ejected, motor controller 520 rotates roller 530 in a first direction 531 so that medium 510 slides out of the player via a loader mechanism in the direction of arrow 532.

Sensor 550 determines whether the medium 510 is still present in the player because if it is, the medium 510 remains in close proximity to sensor 550 and the sensor 550 determines its physical presence. If medium 510 is still present near sensor 550, computing unit 560 is invoked to initiate an ejection routine according to an embodiment of the present invention. First, motor controller 520 reverses motor 530 so that roller 535 turns in direction 570. Roller 535 turning in direction 570 causes medium 510 to move in the direction of arrow 571. Medium 510 is returned to a position of alignment over spindle 500. Instructions 580 in computing unit 560 are executed. This causes status controller 581 to return the player status to PLAY and the disc is rotated 90 degrees on spindle 500. Counter 582 is incremented and motor controller 520 again attempts to move the disc in the direction of arrow 532. This process repeats until the disc is ejected successfully or the counter 582 determines the number of ejection attempts exceeds a threshold and the disc must be removed by another method.

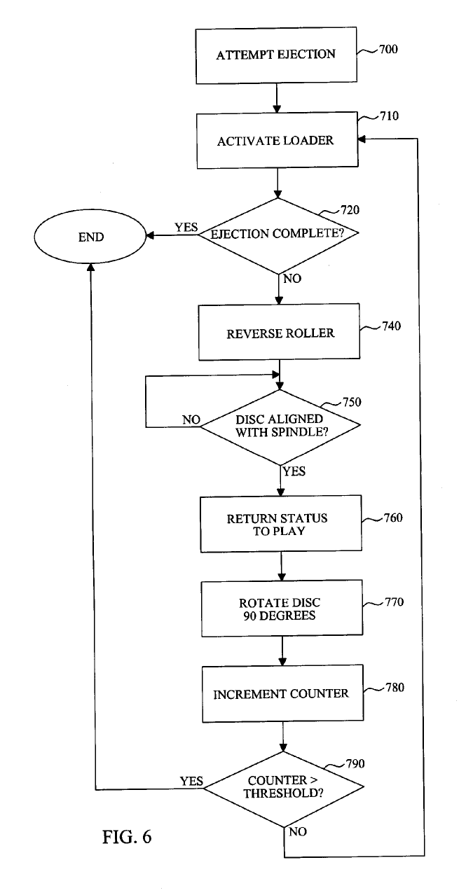

FIG. 6 is a flowchart showing the operation of an ejection routine according to another embodiment of the present invention. At block 700 an attempt is made to eject the disc. At block 710 a loader is activated to carry out the attempted ejection of the disc. At block 720 it is determined if the ejection is complete. If so, the process ends. Otherwise at block 740 a motor controller is used to reverse a motor that controls the roller. This has the effect of pushing the disc back into the player. At block 750, it is determined if the disc is back in alignment with the spindle. If not, the process repeats until the disc is re-loaded into the player.

At block 760 the status of the player is returned to PLAY. At block 770 the disc is rotated 90 degrees. At block 780 a counter is incremented. At block 790 it is determined if the number of ejection attempts exceeds a threshold number of times to try to eject the disc. If so, the process is complete. Otherwise, the process repeats at block 710.

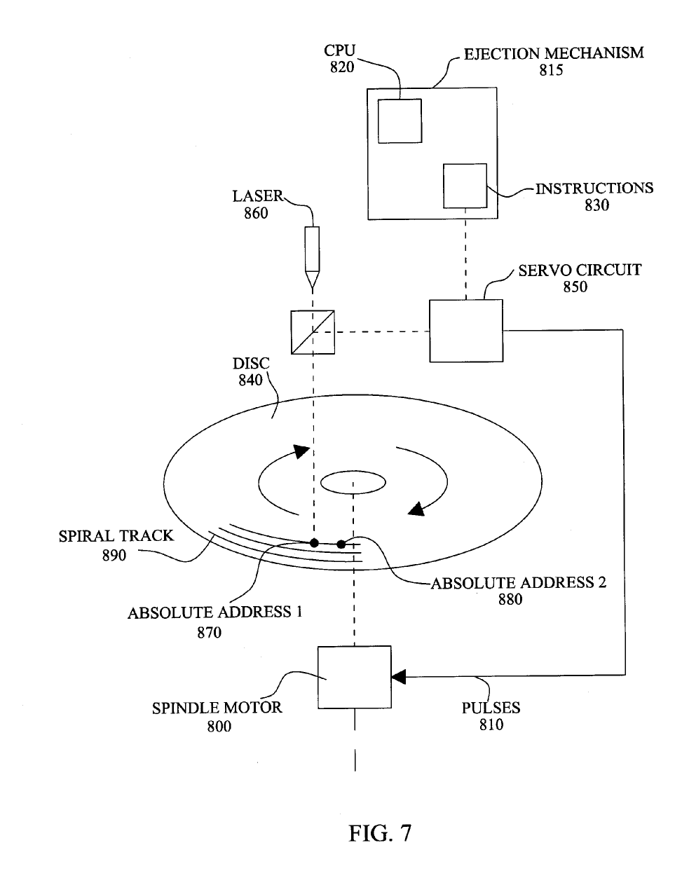

Once the disc has been returned to the player to a position of alignment with the spindle motor, the ejection routine is invoked. FIG. 7 is a block diagram showing the components used in an ejection routine according to an embodiment of the present invention. The player motor used to spin the disc is called a stepper motor or a spindle motor 800 whose angle of rotation is controlled with a series of pulses 810. An ejection mechanism 815 is used having at least a microprocessor 820, or other comparable computing apparatus, having software or firmware instructions 830 for controlling the pulses 810 needed to cause the disc 840 to spin over various angles of rotation (e.g., 90 degrees).

In operation, a servo circuit (spindle motor controller) 850 is implemented where the software or firmware 830 sends a command to the servo circuit 850, which sends pulses 810 to the spindle motor 800. The spindle motor 800 begins to rotate (and hence the disc 840 rotates) and at the same time a laser pickup 860 feeds back a first absolute address 870, which is embedded in a spiral track 890 of the disc 840, to the servo circuit 850. As the disc 840 rotates, the laser 860 continues feeding back absolute addresses, for instance second absolute address 880, and the pulses 810 for the particular spindle motor 800 are generated until the disc 840 is rotated the appropriate amount.

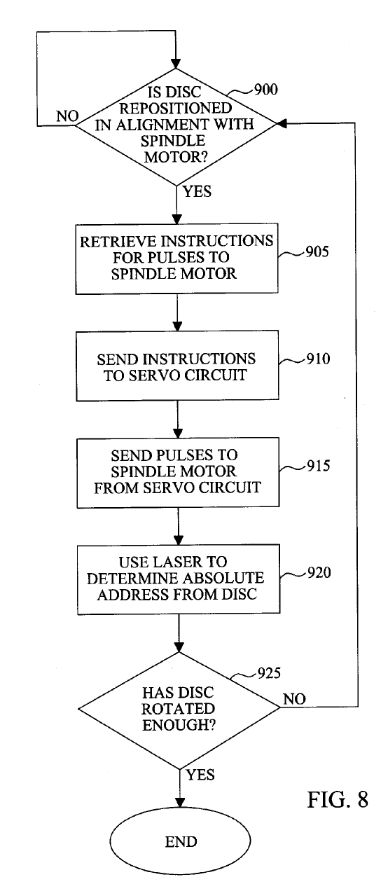

FIG. 8 is a flowchart showing the operation of an ejection routine for an optical disc player according to another embodiment of the present invention. First, it is determined at block 900 if the disc has been re-positioned in alignment with the stepper (spindle) motor. Thus, the disc was not previously ejected successfully and has been returned to its operating position. At block 905, instructions are received from a computing unit that tells the system how to pulse the stepper motor. At block 910, the instructions are sent to a servo circuit. At block 915, a pulse is sent from the servo circuit to the stepper motor. At block 920 a laser is used to read an absolute address from the disc. The absolute address is embedded in the spiral track of the disc along with the other data used to create the music and/or video. At block 925, it is determined if the disc has rotated enough. The system compares the current absolute address to the address indicating the disc has rotated far enough (for example, ninety degrees). If not, the process repeats at block 905. Otherwise, the process is complete.

Although the description above contains many specificities, these should not be construed as limiting the scope of the invention but as merely providing illustrations of some of the presently preferred embodiments of this invention. Thus the scope of this invention should be determined by the appended claims and their legal equivalents.

What is claimed is:

1. A disc playing apparatus comprising:
an area for housing a disc;
an ejection mechanism inside said area for housing said disc;
a sensor for determining when said ejection mechanism has not ejected said disc successfully; and
a routine for rotating said disc and restarting said ejection mechanism.

2. The apparatus of claim 1 wherein said ejection mechanism operates by using a motor to rotate a roller.

3. The apparatus of claim 1 wherein said routine comprises returning said disc player to a PLAY mode.

4. The apparatus of claim 1 wherein said disc is rotated between 90 degrees and 270 degrees.

5. The apparatus of claim 1 wherein said ejection mechanism attempts to eject said disc a given number of times if a first attempt is not successful.

6. The apparatus of claim 5 wherein said given number is five.

7. The apparatus of claim 5 wherein said given number is variable.

8. A method for ejecting a disc from a player comprising:
receiving a command to eject said disc;
attempting to eject said disc;
determining if said disc was not ejected;
rotating said disc; and
ejecting said disc.

9. The method of claim 8 wherein said step of attempting further comprises using a motor to rotate a roller.

10. The method of claim 8 further comprising returning said player to a PLAY mode.

11. The method of claim 8 wherein said step of rotating is configured to rotate said disc between 90 degrees and 270 degrees.

12. The method of claim 8 wherein said step of determining further comprises attempting to eject said disc a given number of times.

13. The method of claim 12 wherein said given number is five.

14. The method of claim 8 wherein said step of determining further comprises using a sensor.

15. A disc player comprising:
an area means for housing a disc;
an ejection means inside said area means for housing said disc;
a sensor means for determining when said ejection mechanism has not ejected said disc successfully; and
a routine means for rotating said disc and restarting said ejection mechanism.

16. The system of claim 15 wherein said ejection means operates by using a motor to rotate a roller.

17. The system of claim 15 wherein said routine means comprises returning said disc player to a PLAY mode.

18. The system of claim 15 wherein said routine means rotates said disc between 90 degrees and 270 degrees.

19. The system of claim 15 wherein said ejection means attempts to eject said disc a given number of times if a first attempt is not successful.

20. The system of claim 19 wherein said given number is five.

21. The system of claim 19 wherein said given number is variable.
